(19) United States
(12) Patent Application Publication
(10) Pub. No.: US 2023/0041722 A1
(43) Pub. Date: Feb. 9, 2023

(54) VEHICLE SURROUNDING MONITOR APPARATUS

(71) Applicant: TOYOTA JIDOSHA KABUSHIKI KAISHA, Toyota-shi (JP)

(72) Inventor: Fumiya Takamaru, Tokai-shi (JP)

(73) Assignee: TOYOTA JIDOSHA KABUSHIKI KAISHA, Toyota-shi (JP)

(21) Appl. No.: 17/847,662

(22) Filed: Jun. 23, 2022

(30) Foreign Application Priority Data
Aug. 6, 2021 (JP) 2021-129788

(51) Int. Cl. B60R 1/23; H04N 7/18

(52) U.S. Cl. CPC B60R 1/23; H04N 7/18; B60R 2300/70; B60R 2300/802; H04N 5/247

(57) ABSTRACT

A vehicle surrounding monitor apparatus comprises a camera which takes images of a view around an own vehicle. The vehicle surrounding monitor apparatus stores the images of the view around the own vehicle taken by the camera, produces a current image under a floor of the own vehicle as an underfloor image by using the stored images, and displays the produced underfloor image on a display. The vehicle surrounding monitor apparatus terminates displaying the underfloor image on the display when time for which the own vehicle has stopped reaches a predetermined first time.

### CROSS-REFERENCE TO RELATED APPLICATIONS

This application claims priority to Japanese patent application No. JP 2021-129788 filed on Aug. 6, 2021, the content of which is hereby incorporated by reference in its entirety.

### BACKGROUND

### Field

The invention relates to a vehicle surrounding monitor apparatus.

### Description of the Related Art

There is known a vehicle surrounding monitor apparatus which displays an underfloor image which shows a view under a floor of an own vehicle. As this kind of the vehicle surrounding monitor apparatus, there is known a vehicle surrounding monitor apparatus which takes an image of a view ahead of the own vehicle by a camera while the own vehicle moves, stores data on the taken images of the view ahead of the own vehicle as image data, picks up the image data representing the current view of a ground surface under the floor of the own vehicle from the stored image data, produces an underfloor image by using the picked-up image data, and displays the produced underfloor image on a display (for example, see JP 2016-197785 A).

As described above, the known vehicle surrounding monitor apparatus produces the underfloor image by using the past image data and displays the produced underfloor image on the display. Thus, the view under the floor of the own vehicle shown by the underfloor image displayed on the display is the past view. Thus, if the own vehicle has stopped for a certain time, the view shown by the underfloor image displayed on the display is probably different from the actual view under the floor of the own vehicle. Thus, when the own vehicle has stopped for a certain time, a driver of the own vehicle probably misunderstands that the view shown by the underfloor image displayed on the display is the actual current view under the floor of the own vehicle.

### SUMMARY

An object of the invention is to provide a vehicle surrounding monitor apparatus which can prevent the driver of the own vehicle from misunderstanding the view under the floor of the own vehicle.

According to the invention, a vehicle surrounding monitor apparatus comprises a camera and an electronic control unit. The camera takes images of a view around an own vehicle. The electronic control unit stores the images of the view around the own vehicle taken by the camera, produces a current image under a floor of the own vehicle as an underfloor image by using the stored images, and displays the produced underfloor image on a display. In addition, the electronic control unit is configured to terminate displaying the underfloor image on the display when time for which the own vehicle has stopped reaches a predetermined first time.

As described above, when the own vehicle has stopped for a certain time, the view under the floor of the own vehicle recognized from the underfloor image displayed on the display is probably different from the actual current view under the floor of the own vehicle. Thus, if the underfloor image is displayed on the display when the own vehicle has stopped for a certain time, and the driver of the own vehicle sees the displayed underfloor image, the driver probably misunderstand the view under the floor of the own vehicle.

With the vehicle surrounding monitor apparatus according to the invention, when the time for which the own vehicle has stopped reaches a certain time (i.e. the predetermined first time), displaying the underfloor image on the display is terminated. Thus, the driver can be prevented from misunderstanding the view under the floor of the own vehicle from the underfloor image displayed on the display.

According to an aspect of the invention, the electronic control unit may be configured to terminate displaying the underfloor image on the display by removing the underfloor image from the display or displaying an image other than the underfloor image on a portion of the display displaying the underfloor image.

With the vehicle surrounding monitor apparatus according to this aspect of the invention, when the time for which the own vehicle has stopped reaches a certain time (i.e., the predetermined first time), the underfloor image is removed from the display, or an image other than the underfloor image is displayed on the portion of the display displaying the underfloor image. Thus, the driver can be prevented from misunderstanding the view under the floor of the own vehicle from the underfloor image displayed on the display.

According to another aspect of the invention, the electronic control unit may be configured to clear the stored images when the time for which the own vehicle has stopped reaches a predetermined second time longer than the predetermined first time.

When the own vehicle starts moving, the underfloor image can be produced by using the stored images, and the produced underfloor image can be displayed on the display, In this case, the produced underfloor image is derived from the past images. Thus, if the underfloor image produced as described above is displayed on the display, and the driver of the own vehicle sees the displayed underfloor image, the driver may misunderstand that the view under the floor of the own vehicle shown by the displayed underfloor image is the current view under the floor of the own vehicle.

With the vehicle surrounding monitor apparatus according to this aspect of the invention, when the time for which the own vehicle has stopped reaches the predetermined second time, the stored images are cleared. Thus, when the own vehicle starts moving, producing the underfloor image by using the past image stored before the own vehicle stops, is not carried out. Thus, the underfloor image produced by using the past image is not displayed on the display. Thus, when the own vehicle starts moving, the driver can be prevented from misunderstanding the view under the floor of the own vehicle.

Elements of the invention are not limited to elements of embodiments and modified examples of the invention described with reference to the drawings. The other objects, features and accompanied advantages of the invention can be easily understood from the embodiments and the modified examples of the invention.

### BRIEF DESCRIPTION OF THE DRAWINGS

FIG. 1 is a view which shows a vehicle surrounding monitor apparatus according to an embodiment of the invention and an own vehicle on which the vehicle surrounding monitor apparatus is installed.

FIG. 2 is a view which shows a shooting range of a front camera and a shooting range of a rear camera.

FIG. 3 is a view which shows a shooting range of a left camera and a shooting range of a right camera.

FIG. 4 is a view which shows areas of storing image data.

FIG. 5 is a view which shows an area in which the own vehicle can move within a predetermined time,

FIG. 6 is a view which shows a relationship between the area of storing the image data and the area in which the own vehicle can move within the predetermined time.

FIG. 7 is a view which shows a display on which a surrounding image and an underfloor image are displayed,

FIG. 8 is a view which describes operations of the vehicle surrounding monitor apparatus according to the embodiment of the invention.

FIG. 9 is a view which describes the operations of the vehicle surrounding monitor apparatus according to the embodiment of the invention.

FIG. 10 is a view which describes the operations of the vehicle surrounding monitor apparatus according to the embodiment of the invention,

FIG. 11 is a view which describes the operations of the vehicle surrounding monitor apparatus according to the embodiment of the invention.

FIG. 12 is a view which describes the operations of the vehicle surrounding monitor apparatus according to the embodiment of the invention.

FIG. 13 is a view which describes the operations of the vehicle surrounding monitor apparatus according to the embodiment of the invention,

FIG. 14 is a view which describes the operations of the vehicle surrounding monitor apparatus according to the embodiment of the invention.

FIG. 15 is a view which describes the operations of the vehicle surrounding monitor apparatus according to the embodiment of the invention.

FIG. 16A is a view which shows a scene that the underfloor image is displayed on the display.

FIG. 16B is a view which shows a scene that displaying the underfloor image on the display is terminated by removing the underfloor image from the display.

FIG. 17A is a view which shows a scene that the underfloor image is displayed on the display.

FIG. 17B is a view which shows a scene that displaying the underfloor image on the display is terminated by displaying a vehicle image on a portion of the display displaying the underfloor image.

FIG. 18 is a view which shows a flowchart of a routine executed by the vehicle surrounding monitor apparatus according to the embodiment of the invention.

FIG. 19 is a view which shows a flowchart of a routine executed by the vehicle surrounding monitor apparatus according to the embodiment of the invention.

FIG. 20 is a view which shows a flowchart of a routine executed by the vehicle surrounding monitor apparatus according to the embodiment of the invention

FIG. 21 is a view which shows a flowchart of a routine executed by the vehicle surrounding monitor apparatus according to the embodiment of the invention.

FIG. 22 is a view which shows a flowchart of a routine executed by the vehicle surrounding monitor apparatus according to the embodiment of the invention.

FIG. 23 is a view which shows a flowchart of a routine executed by the vehicle surrounding monitor apparatus according to the embodiment of the invention.

FIG. 24 is a view which shows a flowchart of a routine executed by the vehicle surrounding monitor apparatus according to the embodiment of the invention.

### DESCRIPTION OF THE EMBODIMENTS

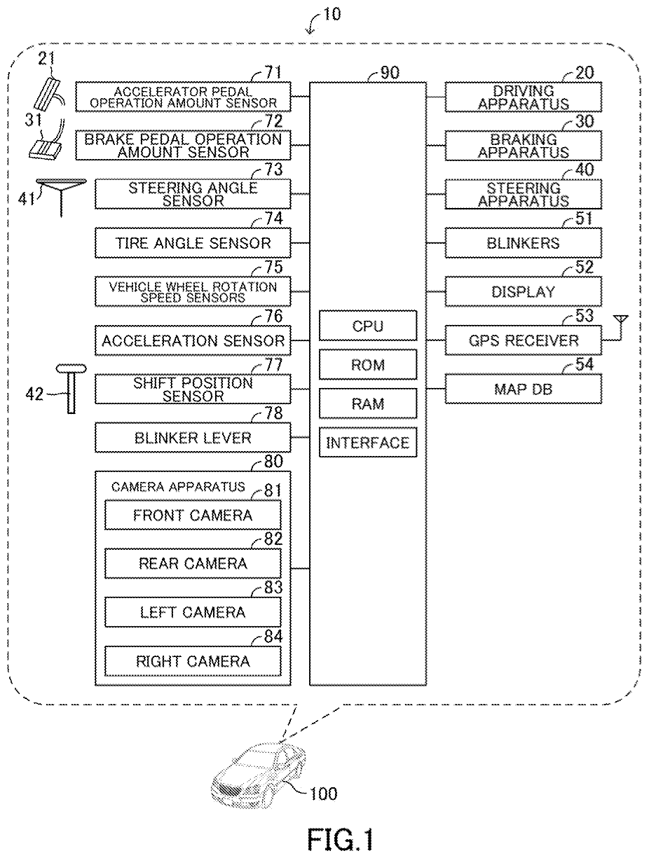

Below, a vehicle surrounding monitor apparatus according to an embodiment of the invention will be described with reference to the drawings. As shown in FIG. 1, the vehicle surrounding monitor apparatus 10 according to the embodiment of the invention is installed on an own vehicle 100.

The own vehicle 100 includes four vehicle wheels, i.e., a left front wheel, a right front wheel, a left rear wheel, and a right rear wheel. In this embodiment, the left and right front wheels are steered wheels as well as driven wheels.

A driving apparatus 20, a braking apparatus 30, and a steering apparatus 40 are also installed on the own vehicle 100. The driving apparatus 20 generates a torque or a vehicle driving torque to be applied to the driven wheels (i.e., the left and right front wheels) of the own vehicle 100 to move the own vehicle 100. In this embodiment, the driving apparatus 20 is an internal combustion engine, In this regard, the driving apparatus 20 may be at least one electric motor. Alternatively, the driving apparatus 20 may be a combination of the internal combustion engine and the electric motor. The braking apparatus 30 generates a braking force to be applied to the wheels (i.e., the left and right front wheels and the left and right rear wheels) of the own vehicle 100 to brake the own vehicle 100. The steering apparatus 40 generates a steering torque to turn the own vehicle 100 left or right. A left turn is turning of the own vehicle 100 in a left direction, and a right turn is turning of the own vehicle 100 in a right direction.

Further, a control unit to control operations of the driving apparatus 20, the braking apparatus 30, and the steering apparatus 40 is installed on the own vehicle 100. The control unit includes an ECU 90. The ECU 90 includes a CPU, a ROM, a RAM, and an interface. The vehicle surrounding monitor apparatus 10 includes the ECU 90 as its component.

As shown in FIG. 1, the driving apparatus 20, the braking apparatus 30, and the steering apparatus 40 are electrically connected to the ECU 90. The ECU 90 can control the vehicle driving torque generated by the driving apparatus 20 by controlling the operations of the driving apparatus 20. Further, the ECU 90 can control the braking force generated by the braking apparatus 30 by controlling the operations of the braking apparatus 30. Furthermore, the ECU 90 can steer the own vehicle 100 by controlling the operations of the steering apparatus 40.

Further, blinkers 51, a display 52, a GP5 receiver 53, and a map database 54 are installed on the own vehicle 100. The blinkers 51, the display 52, the GPS receiver 53, and the map database 54 are electrically connected to the ECU 90.

The blinkers 51 are provided on a left front corner portion, a right front corner portion, a left rear corner portion, and a right rear corner portion of the own vehicle 100, respectively. The blinkers 51 blink in response to various command signals sent from the ECU 90.

The display 52 is provided at a position in the own vehicle 100 such that a driver DR of the own vehicle 100 can see and operate the display 52. The display 52 displays images in response to various command signals sent from the ECU 90. The display 52 is a touch panel. For example, the driver DR can set a destination and requests the ECU 90 to provide the driver DR with a guidance of a route from a current position of the own vehicle 100 to the set destination.

The GP5 receiver 53 receives GPS signals and sends the received GP5 signals to the ECU 90. The map database 54 memorizes map information. The ECU 90 can acquire the current position of the own vehicle 100, based on the GP5 signal, display a map image around the own vehicle 100 on the display 52 with reference to the map information memorized in the map database 54, and display the current position of the own vehicle 100 on the display 52.

Further, when the guidance of the route from the current position of the own vehicle 100 to the set destination is requested by the driver DR carrying out a touch interaction to the display 52, the ECU 90 searches a route to the set destination, based on (i) the map information memorized in the map database 54, (ii) the current position of the own vehicle 100 acquired, based on the GP5 signal, and (iii) the destination set by the driver DR carrying out the touch interaction to the display 52. The ECU 90 displays the searched route on the display 52 and outputs an announcement from a speaker (not shown) of the own vehicle 100 to inform the driver DR of the searched route.

Furthermore, an accelerator pedal operation sensor 71, a brake pedal operation sensor 72, a steering angle sensor 73, a tire angle sensor 74, vehicle wheel rotation speed sensors 75, an acceleration sensor 76, a shift position sensor 77, a blinker lever 78, and a camera apparatus 80. The accelerator pedal operation amount sensor 71, the brake pedal operation amount sensor 72, the steering angle sensor 73, the vehicle wheel rotation speed sensors 75, the acceleration sensor 76, the shift position sensor 77, the tire angle sensor 74, the blinker lever 78, the camera apparatus 80 are electrically connected to the ECU 90,

The accelerator pedal operation amount sensor 71 detects an operation amount of an accelerator pedal 21 of the own vehicle 100 and sends a signal representing the detected operation amount to the ECU 90. The ECU 90 acquires the operation amount of the accelerator pedal 21 as an accelerator pedal operation amount AP, based on the signal sent from the accelerator pedal operation amount sensor 71 and controls the operations of the driving apparatus 20, based on the acquired accelerator pedal operation amount AP,

The brake pedal operation amount sensor 72 detects an operation amount of a brake pedal 31 of the own vehicle 100 and sends a signal representing the detected operation amount to the ECU 90, The ECU 90 acquires the operation amount of the brake pedal 31 as a brake pedal operation amount BP, based on the signal sent from the brake pedal operation amount sensor 72 and controls the operations of the braking apparatus 30, based on the acquired brake pedal operation amount BR

The steering angle sensor 73 detects an angle of a steering wheel 41 of the own vehicle 100 rotated by the driver DR with respect to a neutral position and sends a signal representing the detected angle to the ECU 90, The ECU 90 acquires the angle of the steering wheel 41 rotated by the driver DR with respect to the neutral position as a steering angle SA, based on the signal sent from the steering angle sensor 73 and controls the operations of the steering apparatus 40, based on the acquired steering angle SA. In this embodiment, when the steering wheel 41 is rotated counterclockwise from the neutral position, the steering angle SA acquired is positive. On the other hand, when the steering wheel 41 is rotated clockwise from the neutral position, the steering angle SA acquired is negative.

The tire angle sensor 74 detects at least one of angles of the left and right front wheels of the own vehicle 100 with respect to a longitudinal direction of the own vehicle 100 and sends a signal representing the detected angle to the ECU 90. The ECU 90 acquires at least one of the angles of the left and right wheels of the own vehicle 100 with respect to the longitudinal direction of the own vehicle 100 as a tire angle TA, based on the signal sent from the tire angle sensor 74.

Each of the vehicle wheel rotation speed sensors 75 sends a pulse signal to the ECU 90 each time the corresponding wheel of the own vehicle 100 (i.e., any of the left front wheel, the right front wheel, the left rear wheel, and the right rear wheel) rotates a predetermined angle. The ECU 90 acquires the rotation speeds of the wheels, based on the pulse signals sent from the vehicle wheel rotation speed sensors 75. Then, the ECU 90 acquires a moving speed of the own vehicle 100 as an own vehicle moving speed SPD, based on the acquired rotation speeds.

The acceleration sensor 76 detects a longitudinal acceleration of the own vehicle 100 and sends a signal representing the detected acceleration to the ECU 90. The ECU 90 acquires the longitudinal acceleration of the own vehicle 100 as a longitudinal acceleration G_X, based on the signal sent from the acceleration sensor 76.

The shift position sensor 77 detects a set position at which the shift lever 42 is set and sends a signal representing the detected set position to the ECU 90, The ECU 90 acquires the set position of the shift lever 42, based on the signal sent from the shift position sensor 77. The shift lever 42 is configured to be set at any one of a drive position, a reverse position, a neutral position, and a parking position, The drive position corresponds to a position for transmitting the driving torque to the driven wheels of the own vehicle 100 from the driving apparatus 20 to move the own vehicle 100 forward. The reverse position corresponds to a position for transmitting the driving torque to the driven wheels of the own vehicle 100 from the driving apparatus 20 to move the own vehicle 100 rearward. The neutral position corresponds to a position for not transmitting the driving torque to the driven wheels of the own vehicle 100 from the driving apparatus 20. The parking position corresponds to a position for not transmitting the driving torque to the driven wheels of the own vehicle 100 from the driving apparatus 20 and maintaining the own vehicle 100 stopped.

The blinker lever 78 is a lever which is operated by the driver DR. When the driver DR operates the blinker lever 78 counterclockwise, the blinker lever 78 sends a signal representing that the driver DR operates the blinker lever 78 counterclockwise to the ECU 90. When the ECU 90 receives the signal in question from the blinker lever 78, the ECU 90 blinks the blinkers 51 provided on the left front corner portion and the left rear corner position. On the other hand, when the driver DR operates the blinker lever 78 clockwise, the blinker lever 78 sends a signal representing that the driver DR operates the blinker lever 78 clockwise to the ECU 90. When the ECU 90 receives the signal in question from the blinker lever 78, the ECU 90 blinks the blinkers 51 provided on the right front corner portion and the right rear corner position.

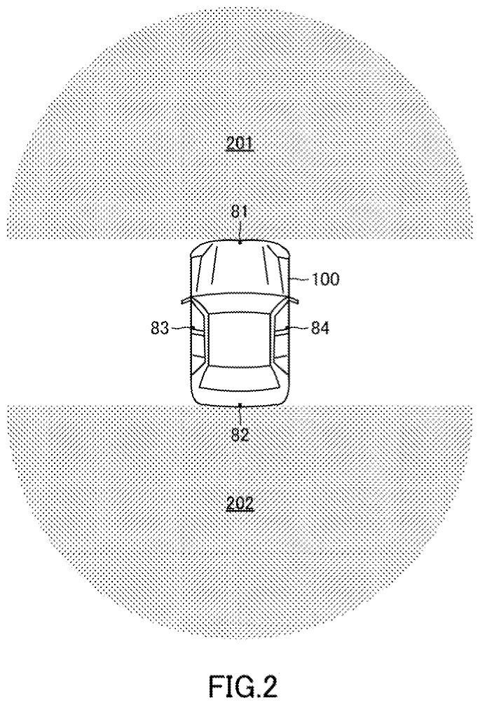

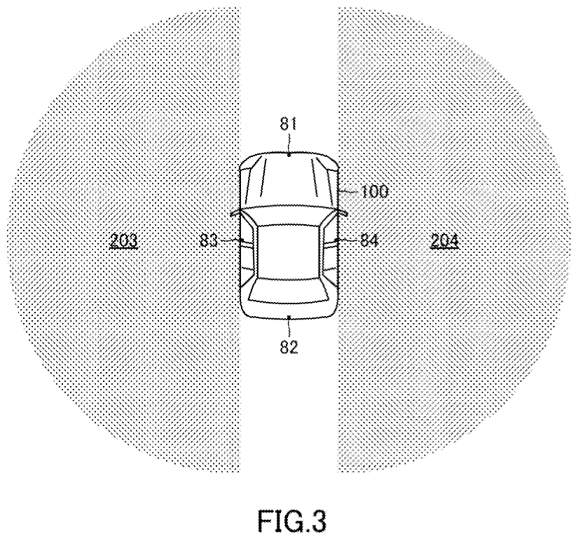

The camera apparatus 80 includes a front camera 81, a rear camera 82, a left camera 83, and a right camera 84. As shown in FIG. 2, the front camera 81 is secured to the own vehicle 100 to take an image in a predetermined range 201 ahead of the own vehicle 100. The rear camera 82 is secured to the own vehicle 100 to take an image in a predetermined range 2D2 behind the own vehicle 100. Further, as shown in FIG. 3, the left camera 83 is secured to the own vehicle 100 to take an image in a predetermined range 203 at the left side of the own vehicle 100. The right camera 84 is secured to the own vehicle 100 to take an image in a predetermined range 204 at the right side of the own vehicle 100,

A left side area of the predetermined range 201 in which the front camera 81 takes the image partially overlaps a forward area of the predetermined range 203 in which the left camera 83 takes the image. A right side area of the predetermined range 201 in which the front camera 81 takes the image partially overlaps a forward area of the predetermined range 204 in which the right camera 84 takes the image. Further, a left side area of the predetermined range 2D2 in which the rear camera 82 takes the image partially overlaps a rearward area of the predetermined range 203 in which the left camera 83 takes the image. A right side area of the predetermined range 2D2 in which the rear camera 82 takes the image partially overlaps a rearward area of the predetermined range 204 in which the right camera 84 takes the image.

The camera apparatus 80 sends forward image data 01, rearward image data D2, left side image data D3, and right side image data D4 to the ECU 90. The forward image data D1 is data on the image taken by the front camera 81. Further, the rearward image data D2 is data on the image taken by the rear camera 82. Furthermore, the left side image data D3 is data on the image taken by the left camera 83. Furthermore, the right side image data 04 is data on the image taken by the right camera 84. Hereinafter, camera image data DO includes the forward image data D1, the rearward image data D2, the left side image data D3, and the right side image data D4.

<Summary of Operations>

Next, a summary of operations of the vehicle surrounding monitor apparatus 10 will be described. When a predetermined condition or an underfloor image display condition is satisfied, the vehicle surrounding monitor apparatus 10 starts to execute a process to produce a perspective image IMG_P including an underfloor image IMG_F as described later and display the produced perspective image IMG_P on the display 52. The underfloor image display condition is, for example, a condition that the own vehicle 100 moves at a low speed to park.

<Storing Image Data>

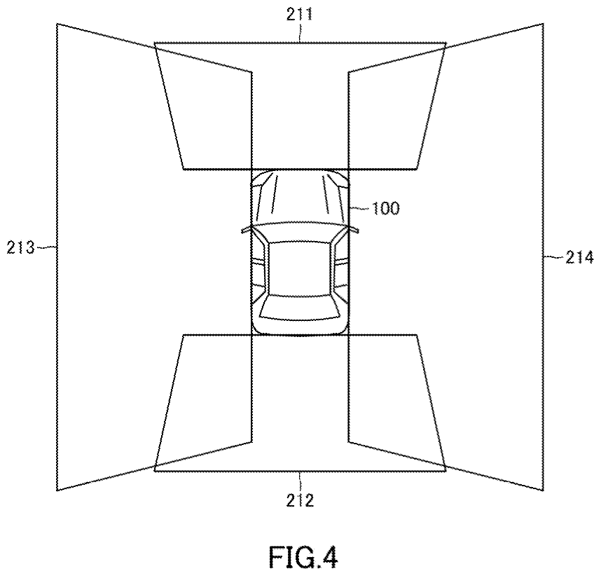

When the vehicle surrounding monitor apparatus 10 produces a surrounding image IMG_S and the underfloor image IMG_F as described later, the vehicle surrounding monitor apparatus 10 is configured to store updated forward image data D11_N in the RAM. The updated forward image data D11_N is the forward image data D1 which has been used to produce the surrounding image IMG_S and relates to a predetermined area 211 (see FIG. 4) ahead of the own vehicle 100. Further, when the vehicle surrounding monitor apparatus 10 produces the surrounding image IMG_S and the underfloor image IMG_F, the vehicle surrounding monitor apparatus 10 is configured to store updated rearward image data D12_N in the RAM. The updated rearward image data D12_N is the rearward image data D2 which has been used to produce the surrounding image IMG_S and relates to a predetermined area 212 (see FIG. 4) behind the own vehicle 100.

Furthermore, when the vehicle surrounding monitor apparatus 10 produces the surrounding image IMG_S and the underfloor image IMG_F, the vehicle surrounding monitor apparatus 10 is configured to store updated left side image data D13_N in the RAM. The updated left side image data D13_N is the left side image data D3 which has been used to produce the surrounding image IMG_S and relates to a predetermined area 213 (see FIG. 4) at the left side of the own vehicle 100, Furthermore, when the vehicle surrounding monitor apparatus 10 produces the surrounding image IMG_S and the underfloor image IMG_F, the vehicle surrounding monitor apparatus 10 is configured to store updated right side image data D14_N in the RAM. The updated right side image data D14_N is the right side image data D4 which has been used to produce the surrounding image IMG_S and relates to a predetermined area 214 (see FIG. 4) at the right side of the own vehicle 100.

The vehicle surrounding monitor apparatus 10 produces the surrounding image IMG_S and the underfloor image IMG_F described later in detail with a predetermined time interval or an image production time interval T_IMG, The surrounding image IMG_S is an image displayed on the display 52 and representing the view around the own vehicle 100, Further, the underfloor image IMG_F is an image displayed on the display 52 and representing the view under a floor of the own vehicle 100.

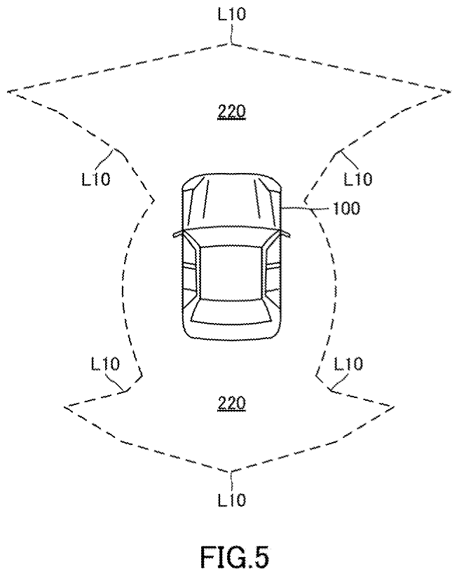

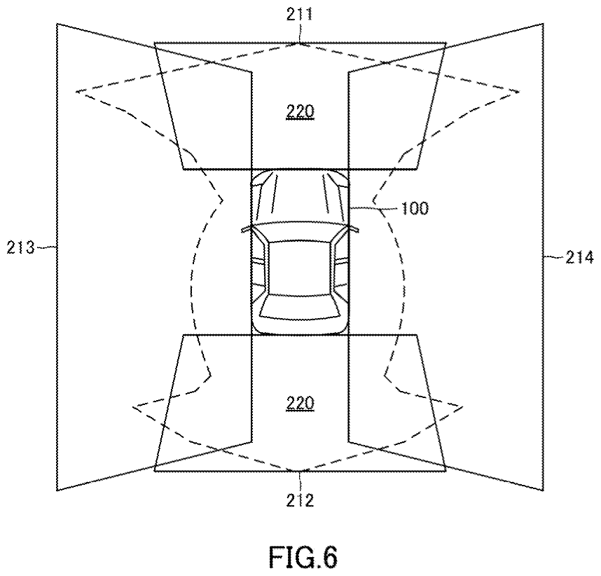

The predetermined area 211 to the predetermined area 214 are set to cover an entire area in which the own vehicle 100 can move within the image production time interval T_IMG. In this embodiment, as shown in FIG. 5, an area 220 defined by a line LID is set as an area in which the own vehicle 100 can move forward within the image production time interval T_IMG and an area in which the own vehicle 100 can move rearward within the image production time interval T_IMG. As shown in FIG. 6, the predetermined area 211 to the predetermined area 214 are set to entirely cover the area 220.

Hereinafter, the updated forward image data D11_N stored in the RAM will be referred to as “past forward image data D11_P.” Similarly, the updated rearward image data D12_N stored in the RAM will be referred to as “past rearward image data D12_P” Similarly, the updated left side image data D13_N stored in the RAM will be referred to as “past left side image data D13_P.” Similarly, the updated right side image data D14_N stored in the RAM will be referred to as “past right side image data D14_P”

Hereinafter, past camera image data D10_P includes the past forward image data D11_P, the past rearward image data D12_P, the past left side image data D13_P, and the past right side image data D14_P.

Further, the vehicle surrounding monitor apparatus 10 is configured to store data or underfloor image data DS on the underfloor image IMG_F produced as described later in the RAM, Hereinafter, the underfloor image data D5 stored in the RAM will be referred to as “past underfloor image data D15_P”

It should be noted that the predetermined area 211 to the predetermined area 214 are set to areas minimally enough to produce the underfloor image IMG_F in consideration of the area in which the own vehicle 100 can move within the image production time interval T_IMG. In this regard, the predetermined area 211 to the predetermined area 214 may be set to areas greater than the areas of this embodiment.

<Producing and Displaying Perspective Image>

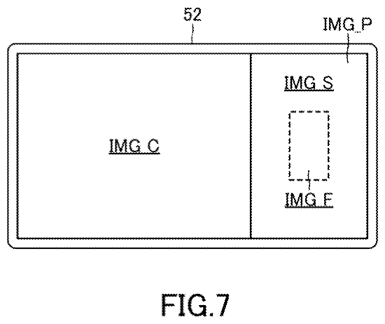

As shown in FIG. 7, the vehicle surrounding monitor apparatus 10 is configured to display the surrounding image IMG_S and the underfloor image IMG_F on the display 52 in the form of the perspective image IMG_P. As described above, the surrounding image IMG_5 is an image which shows the view around the own vehicle 100, and the underfloor image IMG_F is an image which shows the view under the floor of the own vehicle 100. It should be noted that a symbol IMG_C in FIG. 7 is an image or a camera taken image which is currently taken by the camera apparatus 80 and shows the view in a moving direction of the own vehicle 100.

In this embodiment, the camera taken image IMG_C is displayed at a left side area of the display 52, and the perspective image IMG_P is displayed at a right side area of the display 52. The underfloor image IMG_F is displayed at a center of the surrounding image IMG_S in the perspective image IMG_P.

The vehicle surrounding monitor apparatus 10 produces the surrounding image IMG_S, based on the camera image data D0 currently updated (i.e., the forward image data D1, the rearward image data D2, the left side image data D3, and the right side image data D4 currently updated). In addition, the vehicle surrounding monitor apparatus 10 produces the underfloor image IMG_F as described below.

When the own vehicle 100 moves straight forward, the vehicle surrounding monitor apparatus 10 produces the underfloor image IMG_F showing the current view under the floor of the own vehicle 100 by suitably using the past forward image data D11_P and the past underfloor image data D15_P,

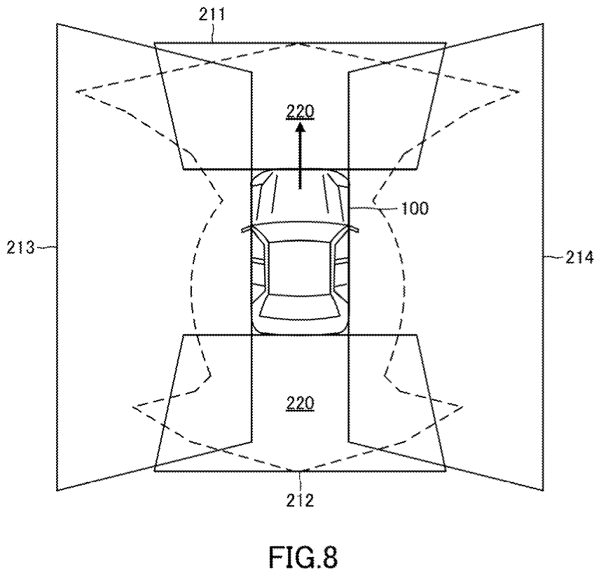

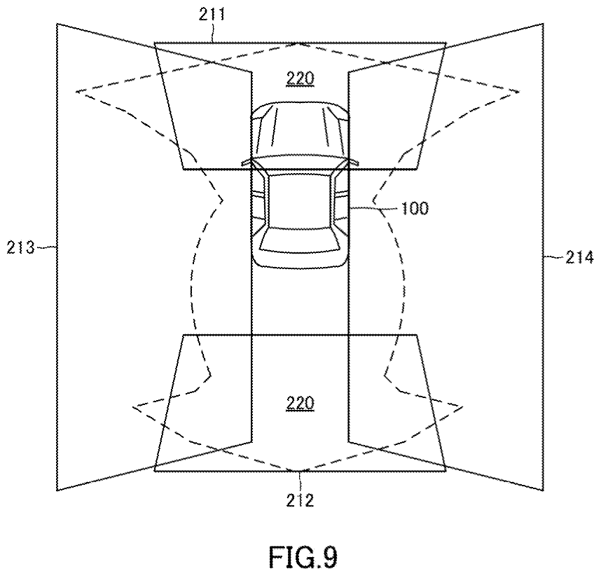

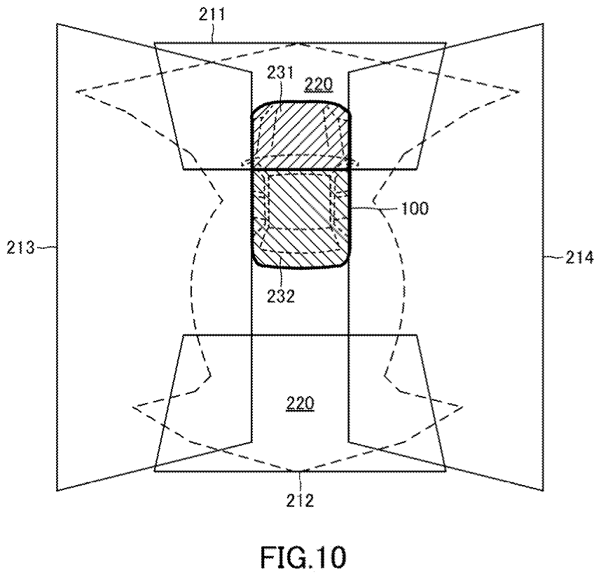

For example, when the own vehicle 100 moves straight forward from a position shown in FIG. 8 to a position shown in FIG. 9, the vehicle surrounding monitor apparatus 10 produces a part of the underfloor image IMG_F showing an area 231 shown in FIG. 10 by using the past forward image data D11_P, produces a part of the underfloor image IMG_F showing an area 232 shown in FIG. 10 by using the past underfloor image data D15_P, and produces the underfloor image IMG_F by synthesizing the produced parts.

Similarly, when the own vehicle 100 moves straight rearward, the vehicle surrounding monitor apparatus 10 produces the underfloor image IMG_F showing the current view under the floor of the own vehicle 100 by suitably using the past rearward image data D12_P and the past underfloor image data D15_P.

Further, when the own vehicle 100 moves forward, turning left, the vehicle surrounding monitor apparatus 10 produces the underfloor image IMG_F showing the current view under the floor of the own vehicle 100 by suitably using the past forward image data D11_P, the past left side image data D13_P, and the past underfloor image data D15_P.

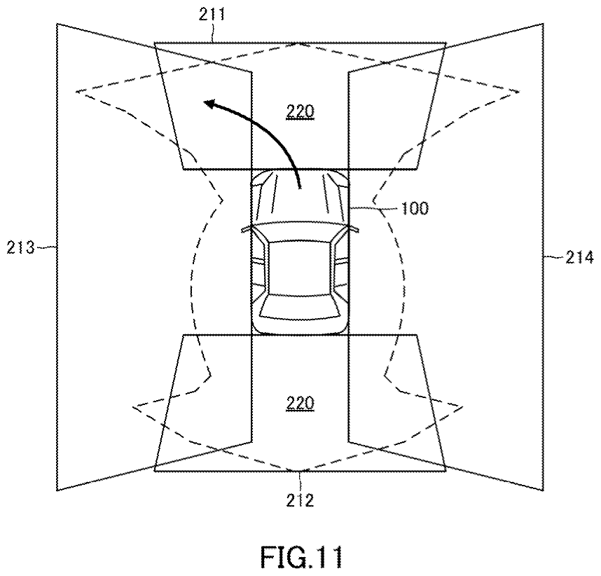

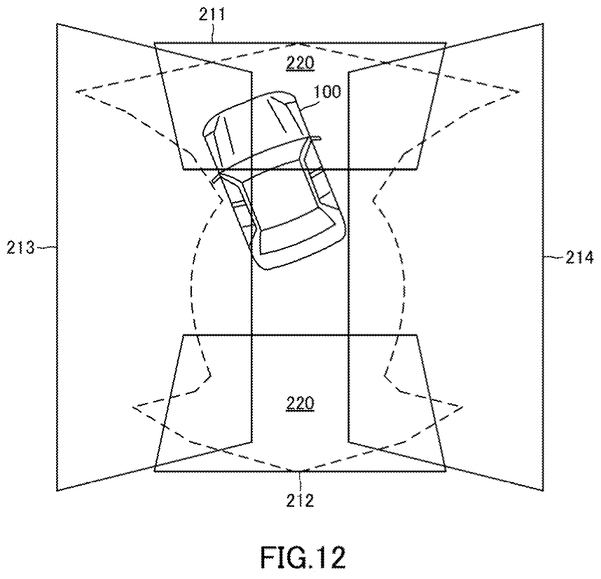

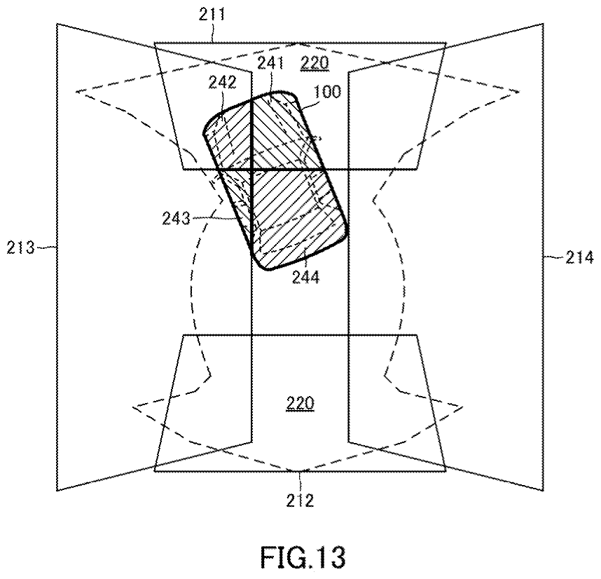

For example, when the own vehicle 100 moves forward, turning left from a position shown in FIG. 11 to a position shown in FIG. 12, the vehicle surrounding monitor apparatus 10 produces a part of the underfloor image IMG_F showing an area 241 shown in FIG. 13 by using the past forward image data D11_P, produces a part of the underfloor image IMG_F showing areas 242 and 243 shown in FIG. 13 by using the past left side image data D13_P, produces a part of the underfloor image IMG_F showing an area 244 shown in FIG. 13 by using the past underfloor image data D15_P, and produces the underfloor image IMG_F by synthesizing the produced parts.

It should be noted that in this embodiment, the part of the underfloor image IMG_F showing the area 242 shown in FIG. 13 is produced by using the past left side image data D13_P In this regard, the part of the underfloor image IMG_F showing the area 242 may be produced by using the past forward image data D11_P. The part of the underfloor image IMG_F produced by using two or more pieces of the past image data may be produced by suitably selecting and using any one or more pieces of the past image data, or by suitably selecting and blending some pieces of the past image data.

Similar to when the own vehicle 100 moves forward, turning left, when the own vehicle 100 moves forward, turning right, the vehicle surrounding monitor apparatus 10 produces the underfloor image IMG_F showing the current view under the floor of the own vehicle 100 by suitably using the past forward image data D11_P, the past right side image data D14_P, and the past underfloor image data D15_P.

Further, when the own vehicle 100 moves rearward, turning left, the vehicle surrounding monitor apparatus 10 produces the underfloor image IMG_F showing the current view under the floor of the own vehicle 100 by suitably using the past rearward image data D12_P, the past right side image data D14_P, and the past underfloor image data D15_P.

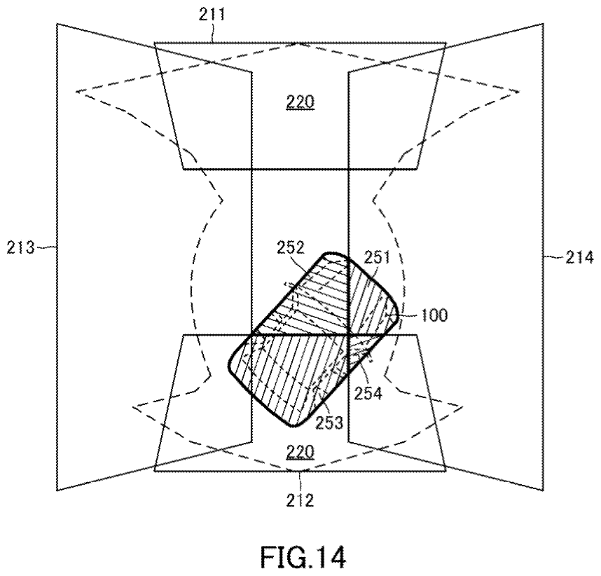

For example, when the own vehicle 100 moves rearward, turning left from a position shown in FIG. 11 to a position shown in FIG. 14, the vehicle surrounding monitor apparatus 10 produces a part of the underfloor image IMG_F showing an area 253 shown in FIG. 14 by using the past rearward image data D12_P, produces a part of the underfloor image IMG_F showing areas 251 and 254 shown in FIG. 14 by using the past right side image data D14_P, produces a part of the underfloor image IMG_F showing an area 252 shown in FIG. 14 by using the past underfloor image data D15_P, and produces the underfloor image IMG_F by synthesizing the produced parts.

It should be noted that in this embodiment, the part of the underfloor image IMG_F showing the area 254 shown in FIG. 14 is produced by using the past right side image data D14_P, In this regard, the part of the underfloor image IMG_F showing the area 254 may be produced by using the past rearward image data D12_P. The part of the underfloor image IMG_F produced by using two or more pieces of the past image data may be produced by suitably selecting and using any one or more pieces of the past image data, or by suitably selecting and blending some pieces of the past image data,

Similar to when the own vehicle 100 moves rearward, turning left, when the own vehicle 100 moves rearward, turning right, the vehicle surrounding monitor apparatus 10 produces the underfloor image IMG_F showing the current view under the floor of the own vehicle 100 by suitably using the past rearward image data D12_P, the past left side image data D13_P, and the past underfloor image data D15_P.

Then, the vehicle surrounding monitor apparatus 10 displays the surrounding image IMG_S and the underfloor image IMG_F produced as described above on the display 52 in the form of the perspective image IMG_P. The perspective image IMG_P is an image seeing from a point above the own vehicle 100.

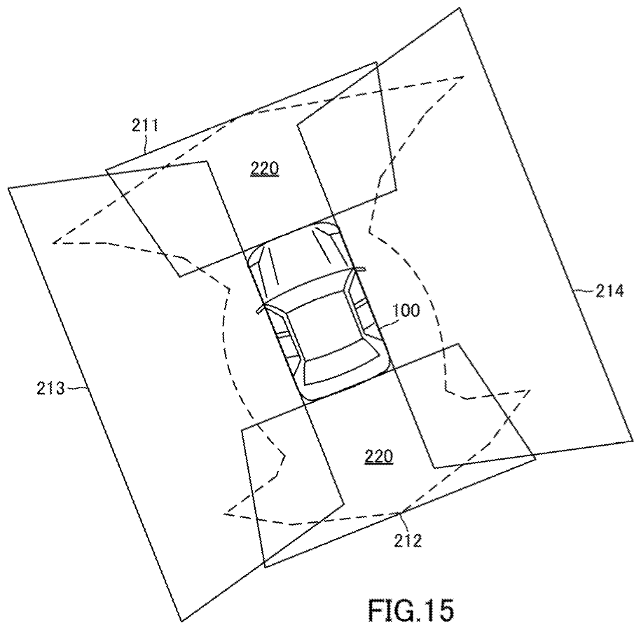

In addition, when the vehicle surrounding monitor apparatus 10 produces the surrounding image IMG_5 and the underfloor image IMG_F, the vehicle surrounding monitor apparatus 10 picks up data on the images showing the predetermined area 211 to the predetermined area 214 (see FIG. 15) set with respect to the current position of the own vehicle 100 from the updated camera image data D0, that is, picks up the updated forward image data D11_N, the updated rearward image data D12_N, the updated left side image data D13_N, and the updated right side image data D14_N on the images showing the predetermined area 211 to the predetermined area 214 from the updated camera image data D0, and stores the picked-up data in the RAM as the new past camera image data D10_P (i.e., the new past forward image data D11_P, the new past rearward image data D12_P, the new past left side image data D13_P, and the new past right side image data D14_P).

Hereinafter, updated camera image data D10_N includes the updated forward image data D11_N, the updated rearward image data D12_N, the updated left side image data D13_N, and the updated right side image data D14_N,

When the own vehicle 100 moves forward, turning, the vehicle surrounding monitor apparatus 10 uses the past left side image data D13_P or the past right side image data D14_P as well as the past forward image data D11_P to produce the underfloor image IMG_F. Thus, when the own vehicle 100 moves forward, turning, the vehicle surrounding monitor apparatus 10 can exactly display the view under the floor of the own vehicle 100 on the display 52.

Further, when the own vehicle 100 moves rearward, turning, the vehicle surrounding monitor apparatus 10 uses the past left side image data D13_P or the past right side image data D14_P as well as the past rearward image data D12_P to produce the underfloor image IMG_F. Thus, when the own vehicle 100 moves rearward, turning, the vehicle surrounding monitor apparatus 10 can exactly display the view under the floor of the own vehicle 100 on the display 52.

It should be noted that when the vehicle surrounding monitor apparatus 10 produces the underfloor image IMG_F, the vehicle surrounding monitor apparatus 10 acquires a relationship between a position of the own vehicle 100 at a point of time when the vehicle surrounding monitor apparatus 10 stores the past camera image data D10_P and the past underfloor image data D15_P last time in the RAM and the current position of the own vehicle 100. Then, the vehicle surrounding monitor apparatus 10 determines what part of the image produced by using the past camera image data D10_P and the past underfloor image data D15_P stored in the RAM is the underfloor image IMG_F, based on the acquired relationship.

<Terminating Displaying Underfloor Image>

As described above, the underfloor image IMG_F is produced by using the past image data (i.e., the past camera image data D10_P and the past underfloor image data D15_P). Thus, specifically, the underfloor image IMG_F is not the image which shows the current view under the floor of the own vehicle 100. Further, when the vehicle surrounding monitor apparatus 10 displays the underfloor image IMG_F on the display 52 while the own vehicle 100 stops, the own vehicle 100 continues displaying the underfloor image IMG_F produced at a point of time when the own vehicle 100 stops on the display 52.

In this regard, if the own vehicle 100 has stopped for a long time, the actual view under the floor of the own vehicle 100 probably changes from the view at a point of time when the own vehicle 100 stops. Thus, when the own vehicle 100 has stopped for a long time, the actual view under the floor of the own vehicle 100 is probably different from the view under the floor of the own vehicle 100 which is shown by the underfloor image IMG_F.

Thus, if the vehicle surrounding monitor apparatus 1.0 continues displaying the underfloor image IMG_F produced at a point of time when the own vehicle 100 stops on the display 52 while the own vehicle 100 stops, and the driver DR sees the underfloor image IMG_F displayed, the driver DR may misunderstand that the view under the floor of the own vehicle 100 which is shown by the underfloor image IMG_F currently displayed is the current view under the floor of the own vehicle 100.

Accordingly, when the own vehicle 100 stops, the vehicle surrounding monitor apparatus 10 starts to measure time or stopping time T which elapses from when the own vehicle 100 stops. Then, until the stopping time T reaches a predetermined time or a first time T1, the vehicle surrounding monitor apparatus 10 continues displaying the underfloor image IMG_F produced at a point of time when the own vehicle 100 stops on the display 52. Then, when the stopping time T reaches the first time T1, the vehicle surrounding monitor apparatus 10 terminates displaying the underfloor image IMG_F on the display 52. It should be noted that the first time T1 is set to several seconds. Further, when the own vehicle moving speed SPD of the own vehicle 100 is zero, the vehicle surrounding monitor apparatus 10 determines that the own vehicle 100 stops.

Thereby, the driver DR can be prevented from misunderstanding the current view under the floor of the own vehicle 100 while the own vehicle 100 stops,

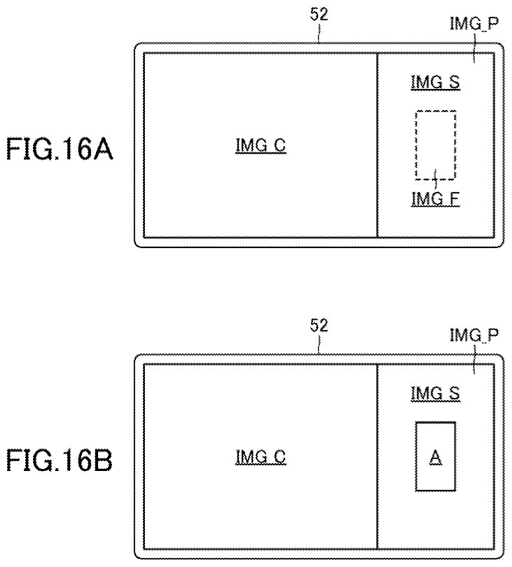

It should be noted that in this embodiment, the vehicle surrounding monitor apparatus 10 continues displaying the underfloor image IMG_F on the display 52 until the stopping time T reaches the first time T1 as shown in FIG. 16A and terminates displaying the underfloor image IMG_F on the display 52 by removing the underfloor image IMG_F from the display 52 when the stopping time T reaches the first time T1 as shown in FIG. 168. It should be noted that in FIG. 168, an area denoted by a symbol A is blank.

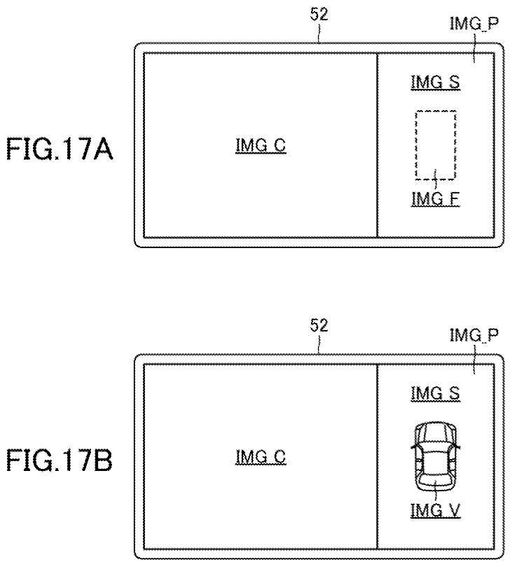

In this regard, the vehicle surrounding monitor apparatus 10 may be configured to continue displaying the underfloor image IMG_F on the display 52 as shown in FIG. 17A until the stopping time T reaches the first time T1, and terminate displaying the underfloor image IMG_F on the display 52 by displaying an image other than the underfloor image IMG_F on a portion of the display 52 displaying the underfloor image IMG_F as shown in FIG. 178 when the stopping time T reaches the first time T1. In an example shown in FIG. 178, the image other than the underfloor image IMG_F is a vehicle image IMG_F or an icon.

In this case, the vehicle surrounding monitor apparatus 10 may be configured to remove the underfloor image IMG_F from the display 52 and display the image other than the underfloor image IMG_F on a portion of the display 52 which had displayed the removed underfloor image IMG_F. Alternatively, the vehicle surrounding monitor apparatus 10 may be configured to display the image other than the underfloor image IMG_F, overlapping the underfloor image IMG_F without removing the underfloor image IMG_F from the display 52.

<Clearing or Deleting Past Image Data>

As described above, the vehicle surrounding monitor apparatus 10 terminates displaying the underfloor image IMG_F on the display 52 at a point of time when the stopping time T reaches the first time T1. In this case, thereafter, when the own vehicle 100 starts to move, the vehicle surrounding monitor apparatus 10 may produce the underfloor image IMG_F by using the past camera image data D10_P and the past underfloor image data D15_P stored in the RAM and display the produced underfloor image IMG_F on the display 52.

In this regard, a part of the underfloor image IMG_F produced immediately after the own vehicle 100 starts to move is produced by using the updated camera image data D10_N, but the most part of the underfloor image IMG_F is produced by using the past camera image data D10_P and the past underfloor image data D15_P. Thus, if the underfloor image IMG_F produced as such is displayed on the display 52, and the driver DR sees the underfloor image IMG_F displayed, the driver DR may misunderstand that the view under the floor of the own vehicle 100 shown by the underfloor image IMG_F is the current view under the floor of the own vehicle 100.

Accordingly, the vehicle surrounding monitor apparatus 10 keeps the past camera image data D10_P and the past underfloor image data D15_P in the RAM without clearing the past camera image data D10_P and the past underfloor image data D15_P from the RAM until the stopping time T reaches a predetermined time or a second time T2 longer than the first time T1 and clears or deletes the past camera image data D10_P and the past underfloor image data D15_P from the RAM at a point of time when the stopping time T reaches the second time T2. It should be noted that in this embodiment, the second time T2 is set to several seconds to over ten seconds.

Thereby, producing the underfloor image IMG_F by using the past camera image data D10_P and the past underfloor image data D15_P stored in the RAM before the own vehicle 100 stops is not carried out when the own vehicle 100 starts to move, Thus, the underfloor image IMG_F produced by using the past camera image data D10_P and the past underfloor image data D15_P stored in the RAM before the own vehicle 100 stops is not displayed on the display 52. Thus, the driver DR can be prevented from misunderstanding the current view under the floor of the own vehicle 100 when the own vehicle 100 starts to move.

It should be noted that when the underfloor image display condition is satisfied after the own vehicle 100 starts to move, the vehicle surrounding monitor apparatus 10 produces the perspective image IMG_P including the underfloor image IMG_F and displays the produced perspective image IMG_P on the display 52 at a point of time when the vehicle surrounding monitor apparatus 10 acquires or stores the past camera image data D10_P enough to produce the underfloor image IMG_F or a part of the underfloor image IMG_F.

It should be noted that the vehicle surrounding monitor apparatus 10 determines whether the own vehicle 100 moves forward or rearward, based on at least one of (i) the set position of the shift lever 42, (ii) the pulse signals output from the vehicle wheel rotation speed sensors 75, (iii) the longitudinal acceleration G_X, (iv) a change of the current position of the own vehicle 100 acquired, based on the GPS signals, and (v) the current position of the own vehicle 100 on the searched route to the destination.

Further, the vehicle surrounding monitor apparatus 10 determines whether the own vehicle 100 turns left or right, based on at least one of (i) the steering angle SA, (ii) the tire angle TA, (iii) a direction of the blinker lever 78 operated, and (iv) the current position of the own vehicle 100 on the searched route to the destination.

<Specific Operations>

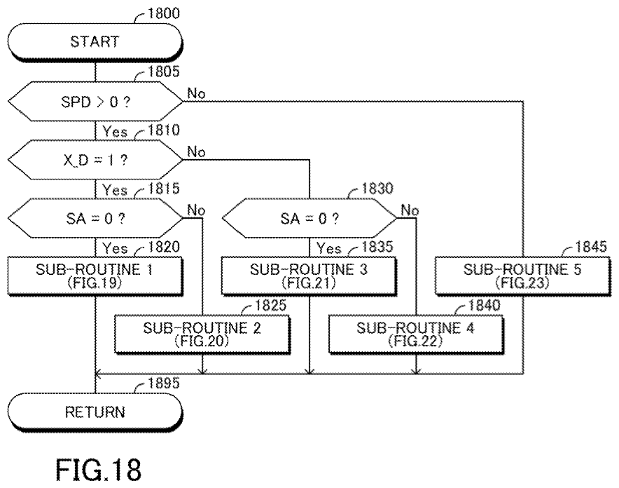

Next, specific operations of the vehicle surrounding monitor apparatus 10 will be described. The CPU of the ECU 90 of the vehicle surrounding monitor apparatus 10 is configured or programmed to execute a routine shown in FIG. 18 each time a predetermined time T_CAL elapses.

Thus, at a predetermined time, the CPU starts a process from a step 1800 of the routine shown in FIG. 18 and proceeds with the process to a step 1805 to determine whether the own vehicle moving speed SPD is greater than zero, that is, the own vehicle 100 is moving.

When the CPU determines “Yes” at the step 1805, the CPU proceeds with the process to a step 1810 to determine whether a value of a drive position flag X_D is “1”, that is, the own vehicle 100 is moving forward. The value of the drive position flag X_D is set to “1” when the shift lever 42 is set to the drive position and is set to “0” when the shift lever 42 is set to a position other than the drive position.

When the CPU determines “Yes” at the step 1810, that is, when the own vehicle 100 is moving forward, the CPU proceeds with the process to a step 1815 to determine whether the steering angle SA is zero, that is, the own vehicle 100 is moving straight forward.

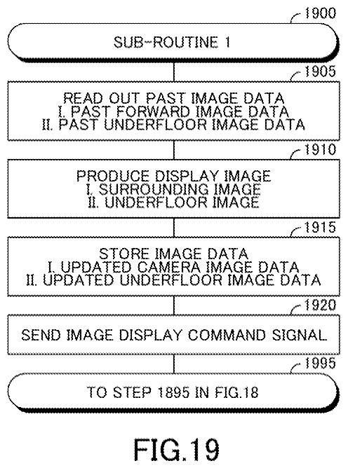

When the CPU determines “Yes” at the step 1815, that is, when the own vehicle 100 is moving straight forward, the CPU proceeds with the process to a step 1820 to execute a routine shown in FIG. 19. Thus, when the CPU proceeds with the process to the step 1820, the CPU starts a process from a step 1900 of the routine shown in FIG. 19 and proceeds with the process to a step 1905 to read out the past forward image data D11_P and the past underfloor image data D15_P from the RAM.

Next, the CPU proceeds with the process to a step 1910 to produce the surrounding image IMG_5, based on the updated camera image data D0, In addition, the CPU produces the underfloor image IMG_F as described above, based on the past forward image data D11_P and the past underfloor image data D15_P read out at the step 1905,

Next, the CPU proceeds with the process to a step 1915 to pick up the updated forward image data D11_N, the updated rearward image data D12_N, the updated left side image data D13_N, and the updated right side image data D14_N from the updated camera image data D0, and stores the picked-up data in the RAM as the new past forward image data D11_P, the new past rearward image data D12_P, the new past left side image data D13_P, and the new past right side image data D14_P. In addition, the CPU stores data on the underfloor image IMG_F produced at the step 1910 or the underfloor image data D5 in the RAM as the new past underfloor image data D15_P.

Next, the CPU proceeds with the process to a step 1920 to send an image display command signal to the display 52. Thereby, the surrounding image IMG_S and the underfloor image IMG_F produced at the step 1910 are displayed on the display 52 in the form of the perspective image IMG_P. Then, the CPU proceeds with the process to a step 1895 of the routine shown in FIG. 18 via a step 1995 to terminate executing this routine once.

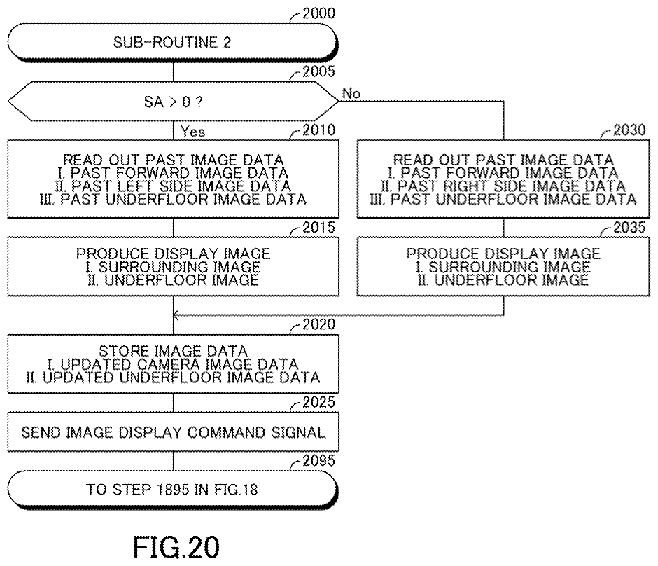

On the other hand, when the CPU determines “No” at the step 1815 of the routine shown in FIG. 18, that is, when the own vehicle 100 is moving forward, turning left or right, the CPU proceeds with the process to a step 1825 to execute a routine shown in FIG. 20, Thus, when the CPU proceeds with the process to the step 1825, the CPU starts a process from a step 2000 of the routine shown in FIG. 20 to determine whether the steering angle SA is greater than zero, that is, the own vehicle 100 is moving forward turning left.

When the CPU determines “Yes” at the step 2005, that is, when the own vehicle 100 is moving forward, turning left, the CPU proceeds with the process to a step 2010 to read out the past forward image data D11_P, the past left side image data D13_P, and the past underfloor image data D15_P from the RAM,

Next, the CPU proceeds with the process to a step 2015 to produce the surrounding image IMG_S, based on the updated camera image data D0. In addition, the CPU produces the underfloor image IMG_F as described above, based on the past forward image data D11_P, the past left side image data D13_P, and the past underfloor image data D15_P read out at the step 2010.

Next, the CPU proceeds with the process to a step 2020 to pick up the updated camera image data D10_N from the updated camera image data D0 and store the picked-up data in the RAM as the new past camera image data D10_P. In addition, the CPU stores the data on the underfloor image IMG_F produced at the step 2015 or the underfloor image data D5 in the RAM as the new past underfloor image data D15_P.

Next, the CPU proceeds with the process to a step 2025 to send the image display command signal to the display 52. Thereby, the surrounding image IMG_S and the underfloor image IMG_F produced at the step 2015 are displayed on the display 52 in the form of the perspective image IMG_P. Then, the CPU proceeds with the process to the step 1895 of the routine shown in FIG. 18 via a step 2095 to terminate executing this routine once.

On the other hand, when the CPU determines “No” at the step 2005, that is, the own vehicle 100 is moving forward, turning right, the CPU proceeds with the process to a step 2030 to read out the past forward image data D11_P the past right side image data D14_P, and the past underfloor image data D15_P from the RAM.

Next, the CPU proceeds with the process to a step 2035 to produce the surrounding image IMG_S, based on the updated camera image data D0. In addition, the CPU produces the underfloor image IMG_F as described above, based on the past forward image data D11_P, the past right side image data D14_P, and the past underfloor image data D15_P read out at the step 2030.

Next, the CPU proceeds with the process to the step 2020 to pick up the updated camera image data D10_N from the updated camera image data D0 and store the picked-up data in the RAM as the new past camera image data D10_P. In addition, the CPU stores the data on the underfloor image IMG_F produced at the step 2035 or the underfloor image data D5 in the RAM as the new past underfloor image data D15_P.

Next, the CPU proceeds with the process to the step 2025 to send the image display command signal to the display 52. Thereby, the surrounding image IMG_S and the underfloor image IMG_F produced at the step 2035 are displayed on the display 52 in the form of the perspective image IMG_P. Then, the CPU proceeds with the process to the step 1895 of the routine shown in FIG. 18 via the step 2095 to terminate executing this routine once.

When the CPU determines “No” at the step 1810 of the routine shown in FIG. 18, that is, when the own vehicle 100 is moving rearward, the CPU proceeds with the process to a step 1830 to determine the steering angle SA is zero, that is, the own vehicle 100 is moving straight rearward.

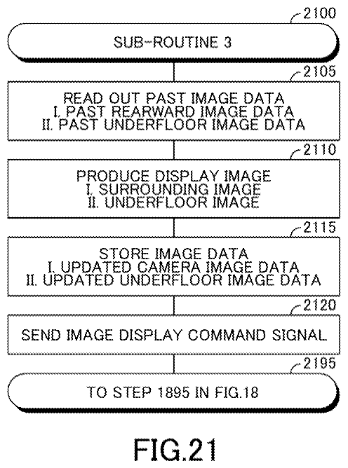

When the CPU determines “Yes” at the step 1830, that is, when the own vehicle 100 is moving straight rearward, the CPU proceeds with the process to a step 1835 to execute a routine shown in FIG. 21. Thus, when the CPU proceeds with the process to the step 1835, the CPU starts a process from a step 2100 of the routine shown in FIG. 21 and proceeds with the process to a step 2105 to read out the past rearward image data D12_P and the past underfloor image data D15_P from the RAM.

Next, the CPU proceeds with the process to a step 2110 to produce the surrounding image IMG_S, based on the updated camera image data D0. in addition, the CPU produces the underfloor image IMG_F as described above, based on the past rearward image data D12_P and the past underfloor image data D15_P read out at the step 2105.

Next, the CPU proceeds with the process to a step 2115 to pick up the updated camera image data D10_N from the updated camera image data D0, and stores the picked-up data in the RAM as the new past camera image data D10_P. In addition, the CPU stores data on the underfloor image IMG_F produced at the step 2110 or the underfloor image data D5 in the RAM as the new past underfloor image data D15_P,

Next, the CPU proceeds with the process to a step 2120 to send the image display command signal to the display 52. Thereby, the surrounding image IMG_S and the underfloor image IMG_F produced at the step 2110 are displayed on the display 52 in the form of the perspective image IMG_P, Then, the CPU proceeds with the process to the step 1895 of the routine shown in FIG. 18 via a step 2195 to terminate executing this routine once.

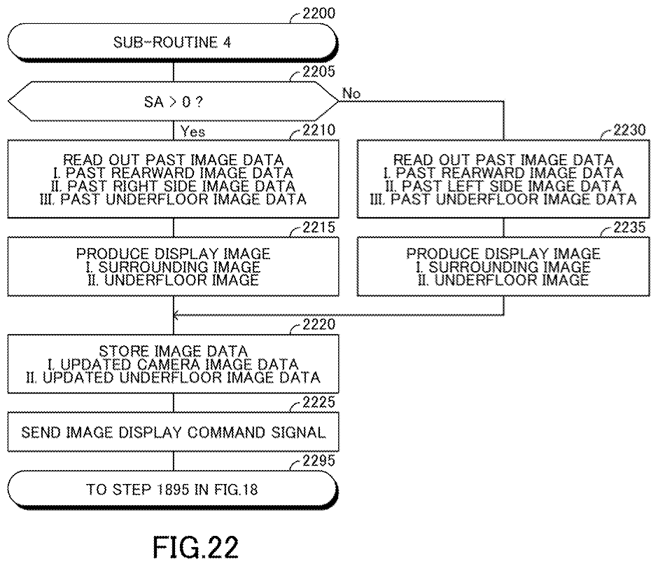

On the other hand, when the CPU determines “No” at the step 1830 of the routine shown in FIG. 18, that is, when the own vehicle 100 is moving rearward, turning left or right, the CPU proceeds with the process to a step 1840 to execute a routine shown in FIG. 22. Thus, when the CPU proceeds with the process to the step 1840, the CPU starts a process from a step 2200 of the routine shown in FIG. 22 to determine whether the steering angle SA is greater than zero, that is, the own vehicle 100 is moving forward turning left.

When the CPU determines “Yes” at the step 2205, that is, when the own vehicle 100 is moving rearward, turning left, the CPU proceeds with the process to a step 2210 to read out the past rearward image data D12_P the past right side image data D14_P, and the past underfloor image data D15_P from the RAM.

Next, the CPU proceeds with the process to a step 2215 to produce the surrounding image IMG_S, based on the updated camera image data D0. in addition, the CPU produces the underfloor image IMG_F as described above, based on the past rearward image data D12_P, the past right side image data D14_P, and the past underfloor image data D15_P read out at the step 2210.

Next, the CPU proceeds with the process to a step 2220 to pick up the updated camera image data D10_N from the updated camera image data 00 and store the picked-up data in the RAM as the new past camera image data D10_P. In addition, the CPU stores the data on the underfloor image IMG_F produced at the step 2215 or the underfloor image data D5 in the RAM as the new past underfloor image data D15_P.

Next, the CPU proceeds with the process to a step 2225 to send the image display command signal to the display 52. Thereby, the surrounding image IMG_S and the underfloor image IMG_F produced at the step 2215 are displayed on the display 52 in the form of the perspective image IMG_P. Then, the CPU proceeds with the process to the step 1895 of the routine shown in FIG. 18 via a step 2295 to terminate executing this routine once.

On the other hand, when the CPU determines “No” at the step 2205, that is, the own vehicle 100 is moving forward, turning right, the CPU proceeds with the process to a step 2230 to read out the past rearward image data D12_P, the past left side image data D13_P, and the past underfloor image data D15_P from the RAM.

Next, the CPU proceeds with the process to a step 2235 to produce the surrounding image IMG_5, based on the updated camera image data D0, In addition, the CPU produces the underfloor image IMG_F as described above, based on the past rearward image data D12_P, the past left side image data D13_P, and the past underfloor image data D15_P read out at the step 2230.

Next, the CPU proceeds with the process to the step 2220 to pick up the updated camera image data D10_N from the updated camera image data D0 and store the picked-up data in the RAM as the new past camera image data D10_P. in addition, the CPU stores the data on the underfloor image IMG_F produced at the step 2235 or the underfloor image data D5 in the RAM as the new past underfloor image data D15_P.

Next, the CPU proceeds with the process to the step 2225 to send the image display command signal to the display 52. Thereby, the surrounding image IMG_5 and the underfloor image IMG_F produced at the step 2235 are displayed on the display 52 in the form of the perspective image IMG_P. Then, the CPU proceeds with the process to the step 1895 of the routine shown in FIG. 18 via the step 2295 to terminate executing this routine once.

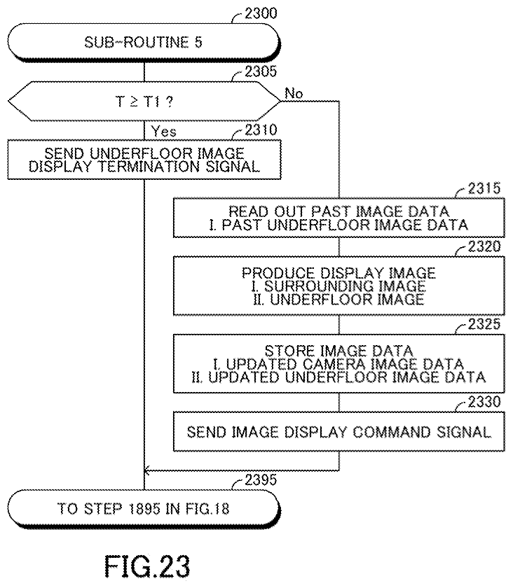

When the CPU determines “No” at the step 1805 of the routine shown in FIG. 18, that is, when the own vehicle 100 stops, or the shift lever 42 is set to the neutral position or the parking position, the CPU proceeds with the process to a step 1845 to execute a routine shown in FIG. 23. Thus, when the CPU proceeds with the process to the step 1845, the CPU starts a process from a step 2300 of the routine shown in FIG. 23 and proceeds with the process to a step 2305 to determine whether the stopping time T is equal to or greater than the first time T1.

When the CPU determines “Yes” at the step 2305, the CPU proceeds with the process to a step 2310 to send an underfloor image display termination command signal to the display 52. Thereby, displaying the underfloor image IMG_F on the display 52 is terminated.

Then, the CPU proceeds with the process to the step 1895 of the routine shown in FIG. 18 via a step 2395 to terminate executing this routine once.

On the other hand, when the CPU determines “No” at the step 2305, the CPU proceeds with the process to a step 2315 to read out the past underfloor image data D15_P from the RAM.

Next, the CPU proceeds with the process to a step 2320 to produce the surrounding image IMG_5, based on the updated camera image data D0. In addition, the CPU produces the underfloor image IMG_F, based on the past underfloor image data D15_P read out at the step 2315. The underfloor image IMG_F produced this time is the same as the underfloor image IMG_F represented by the past underfloor image data D15_P,

Next, the CPU proceeds with the process to a step 2325 to pick up the updated camera image data D10_N from the updated camera image data D0 and store the picked-up data in the RAM as the new past camera image data D10_P. In addition, the CPU stores the data on the underfloor image IMG_F produced at the step 2320 or the underfloor image data DS in the RAM as the new past underfloor image data D15_P,

Next, the CPU proceeds with the process to a step 2330 to send the image display command signal to the display 52. Thereby, the surrounding image IMG_S and the underfloor image IMG_F produced at the step 2320 are displayed on the display 52 in the form of the perspective image IMG_P. Then, the CPU proceeds with the process to the step 1895 of the routine shown in FIG. 18 via the step 2395 to terminate executing this routine once.

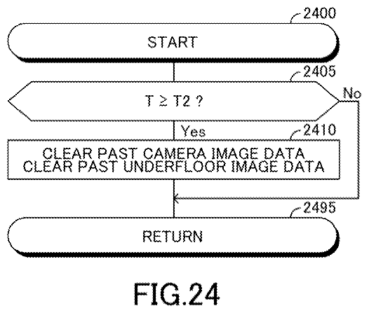

Further, the CPU is configured or programmed to execute a routine shown in FIG. 24 each time the predetermined time T_CAL elapses. Thus, at a predetermined time, the CPU starts a process from a step 2400 of the routine shown in FIG. 24 and proceeds with the process to a step 2405 to determine whether the stopping time T is equal to or greater than the second time T2.

When the CPU determines “Yes” at the step 2405, the CPU proceeds with the process to a step 2410 to clear the past camera image data D10_P and the past underfloor image data D15_P from the RAM. Then, the CPU proceeds with the process to a step 2495 to terminate executing this routine once.

On the other hand, when the CPU determines “No” at the step 2405, the CPU proceeds with the process directly to the step 2495 to terminate executing this routine once. In this case, the past camera image data D10_P and the past underfloor image data D15_P in the RAM are not cleared,

The specific operations of the vehicle surrounding monitor apparatus 10 have been described.

It should be noted that the invention is not limited to the aforementioned embodiments, and various modifications can be employed within the scope of the invention.

What is claimed is:

1. A vehicle surrounding monitor apparatus, comprising:
a camera which takes images of a view around an own vehicle; and
an electronic control unit which stores the images of the view around the own vehicle taken by the camera, produces a current image under a floor of the own vehicle as an underfloor image by using the stored images, and displays the produced underfloor image on a display,
wherein the electronic control unit is configured to terminate displaying the underfloor image on the display when time for which the own vehicle has stopped reaches a predetermined first time.

2. The vehicle surrounding monitor apparatus as set forth in claim 1, wherein the electronic control unit is configured to terminate displaying the underfloor image on the display by removing the underfloor image from the display or displaying an image other than the underfloor image on a portion of the display displaying the underfloor image.

3. The vehicle surrounding monitor apparatus as set forth in claim 1, wherein the electronic control unit is configured to clear the stored images when the time for which the own vehicle has stopped reaches a predetermined second time longer than the predetermined first time.
